(19) United States
(12) Patent Application Publication
(10) Pub. No.: US 2012/0018228 A1
(43) Pub. Date: Jan. 26, 2012

(54) Method and Apparatus for Transforming a Pressure Drop into a Continuous Fluid Flow

(75) Inventor: Niko Spreckelmeyer, Celle (DE)

(73) Assignee: BAKER HUGHES INCORPORATED, Houston, TX (US)

(21) Appl. No.: 13/190,201

(22) Filed: Jul. 25, 2011

Related U.S. Application Data
(60) Provisional application No. 61/367,826, filed on Jul. 26, 2010.

(51) Int. Cl. E21B 4/02; B67D 7/70; E21B 7/00

(52) U.S. Cl. 175/107; 175/57; 137/565.29

(57) ABSTRACT

An apparatus energizes a consumer of a pressurized fluid using a high pressure source and a low pressure source. The apparatus may include a fluid circuit in fluid communication with the consumer. The fluid circuit may have a first and a second reservoir. In one arrangement, the fluid circuit may have a flow control device in pressure communication with the first pressure source and the second pressure source, the flow control device being configured to cycle a pressure applied to the first and the second reservoirs using the first pressure source and the second pressure source. In some arrangements, the fluid circuit may include a flow device configured to flow fluid from a second branch to a first branch of the reservoir, and a flow control device in fluid communication with the flow device, the flow control device being configured to cycle a pressure applied to the flow device.

### CROSS-REFERENCE TO RELATED APPLICATIONS

This application claims priority from U.S. Provisional Patent Application Ser. No. 61/367,826 filed Jul. 26, 2010 the disclosure of which is incorporated herein by reference in its entirety.

### BACKGROUND OF THE DISCLOSURE

1. Field of the Disclosure

This disclosure relates generally to oilfield downhole tools and more particularly to drilling assemblies utilized for directionally drilling wellbores.

2. Background of the Art

Boreholes or wellbores are drilled by rotating a drill bit attached to the bottom of a drilling assembly (also referred to herein as a “Bottom Hole Assembly” or (“BHA”). The BHA may be attached to the bottom of a tubing or tubular string, which is usually either a jointed rigid pipe (or “drill pipe”) or a relatively flexible spoolable tubing commonly referred to in the art as “coiled tubing.” The string comprising the tubing and the drilling assembly is usually referred to as the “drill string.” When jointed pipe is utilized as the tubing, the drill bit is rotated by rotating the jointed pipe from the surface and/or by a mud motor contained in the drilling assembly. In the case of coiled tubing, the drill bit is rotated by the mud motor. The BHA may incorporate a number of tools and devices that are energized by pressurized hydraulic fluid.

The present disclosure addresses the need to supply pressurized hydraulic fluid.

### SUMMARY OF THE DISCLOSURE

In aspects, the present disclosure provides devices for energizing a consumer of a pressurized fluid. The devices may use a first pressure source and a second pressure source having a pressure lower than the first pressure source. One illustrative device may include a fluid circuit in fluid communication with the consumer, the fluid circuit having a first and a second reservoir; and a flow control device in pressure communication with the first pressure source and the second pressure source, the flow control device being configured to cycle a pressure applied to the first and the second reservoirs using the first pressure source and the second pressure source. Another illustrative device may include a fluid circuit in fluid communication with the consumer, the fluid circuit including a first branch supplying pressurized fluid to the reservoir, a second branch receiving fluid from the reservoir, a flow device configured to flow fluid from the second branch to the first branch, and a flow control device in fluid communication with the flow device, the flow control device being configured to cycle a pressure applied to the flow device.

In aspects, the present disclosure provides methods for energizing a consumer of a pressurized fluid. The methods may use a first pressure source and a second pressure source having a pressure lower than the first pressure source. One illustrative method may include circulating fluid using a first and a second reservoir in fluid communication with the consumer; and cycling a pressure applied to the first and the second reservoirs using a flow control device in pressure communication with the first pressure source and the second pressure source. Another illustrative method may include providing fluid communication with the consumer using a fluid circuit having a first and a second branch, flowing a fluid from the second branch to the first branch using a flow device, and cycling a pressure applied to the flow device using the first and the second pressure source.

Examples of certain features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 illustrates a wellbore construction system made in accordance with one embodiment of the present disclosure;

FIG. 2 schematically illustrates a BHA that includes illustrative consumers of pressurized hydraulic fluid;

FIG. 3 schematically illustrates an embodiment of a fluid circuit according to the present disclosure; and

FIG. 4 schematically illustrates another embodiment of a fluid circuit according to the present disclosure.

### DETAILED DESCRIPTION OF THE DISCLOSURE

In aspects, the present disclosure provides systems and methods that transform an available pressure drop into a continuous hydraulic oil flow for a fluid circuit. One illustrative, but not exclusive, available pressure drop is the differential pressure between an inner bore of a drill string and a wellbore annulus. This pressure differential occurs while mud flow is pumped through the drill string and the pressure of the inner bore is higher than the pressure of the outer bore. As will be described in greater detail below, embodiments of the present disclosure selectively apply this pressure differential to reservoirs of a fluid circuit to achieve a flow through a hydraulic system.

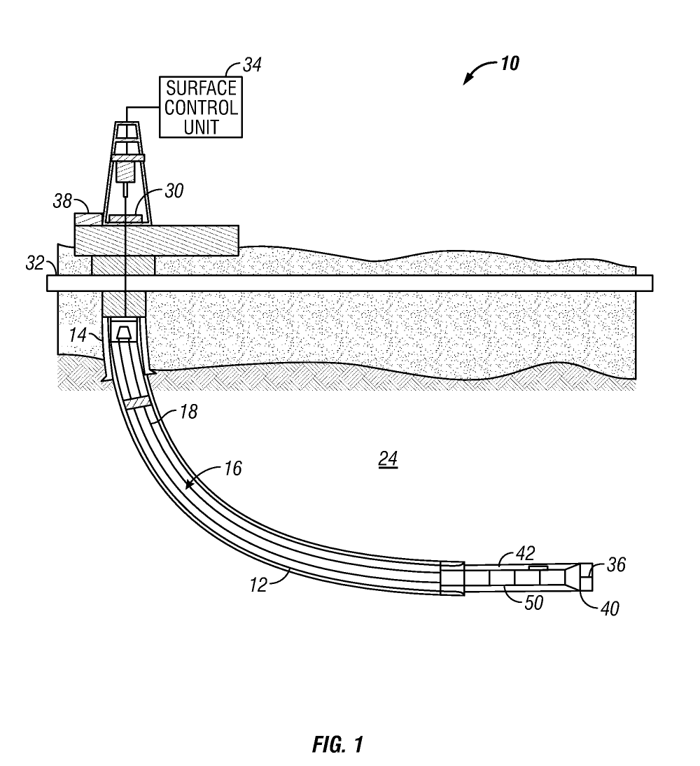

FIG. 1 is a schematic diagram showing a drilling system 10 for drilling wellbores according to one embodiment of the present disclosure. FIG. 1 shows a wellbore 12 that traverses a formation 24 of interest. The wellbore 12 may include a casing 14 with a drill string 16. The drill string 16 includes a tubular member 18 that carries a bottomhole assembly (BHA) 50 at a distal end. The tubular member 18 may be made up by joining drill pipe sections. The drill string 16 extends to a rig 30 at the surface 32. The drill string 16, which may be jointed tubulars or coiled tubing, may include power and/or data conductors such as wires for providing bidirectional communication and power transmission. A top drive (not shown), or other suitable rotary power source, may be utilized to rotate the drill string 16. A controller 34 may be placed at the surface 32 for receiving and processing downhole data. The controller 34 may include a processor, a storage device for storing data, and computer programs. The processor accesses the data and programs from the storage device and executes the instructions contained in the programs to control the drilling operations. During drilling operations, a suitable drilling fluid 36 is circulated under pressure through a bore in the drill string 16 by a mud pump 38. The drilling fluid 36 is discharged at the borehole bottom through an opening in the drill bit 40. The drilling fluid 36 circulates uphole through the annular space 42 between the drill string 16 and a wall of the borehole 12.

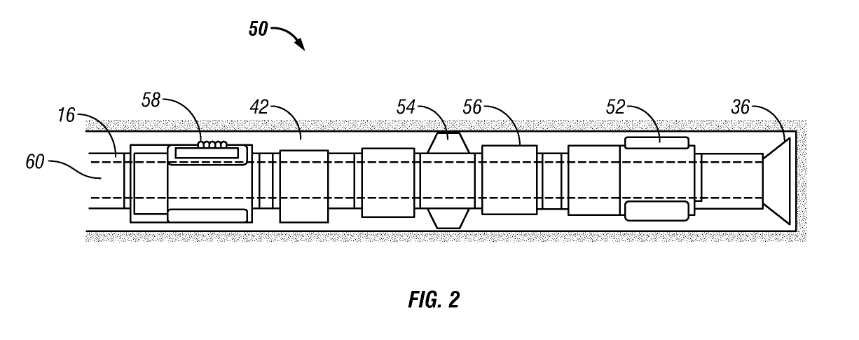

Referring now to FIG. 2, the BHA 50 may include a variety of components or devices that use pressurized fluid as the energy source for performing one or more functions. Closed hydraulic fluid circuits may be used in a steering device 52 to selectively extend and retract force application members that apply steering forces to a wellbore wall, a stabilizer 54 to extend blades for positioning the drill string 16, formation evaluation tools 56 to operate coring devices or fluid sampling tools, or a hole enlargement device 58 to extend cutting blades or enlarging a section of a wellbore. As used herein, a fluid circuit is a path formed in one or more components along which a fluid flows. As used herein, the term “consumer” refers to any device, tool, or system that uses pressurized fluid as the energy source for performing one or more functions. The consumer may be in the BHA 50 or elsewhere in the wellbore 12. As will be described in greater detail below, one or more consumers may be energized with hydraulic fluid that is circulated using a pressure differential between a high pressure fluid in the bore 60, the high pressure source, and a lower pressure fluid in the annulus 42, the low pressure source. It should be understood, however, that the present teachings may utilize separated pressure sources. That is, the high pressure source may be based on a first fluid and the low pressure source may be based on a different fluid.

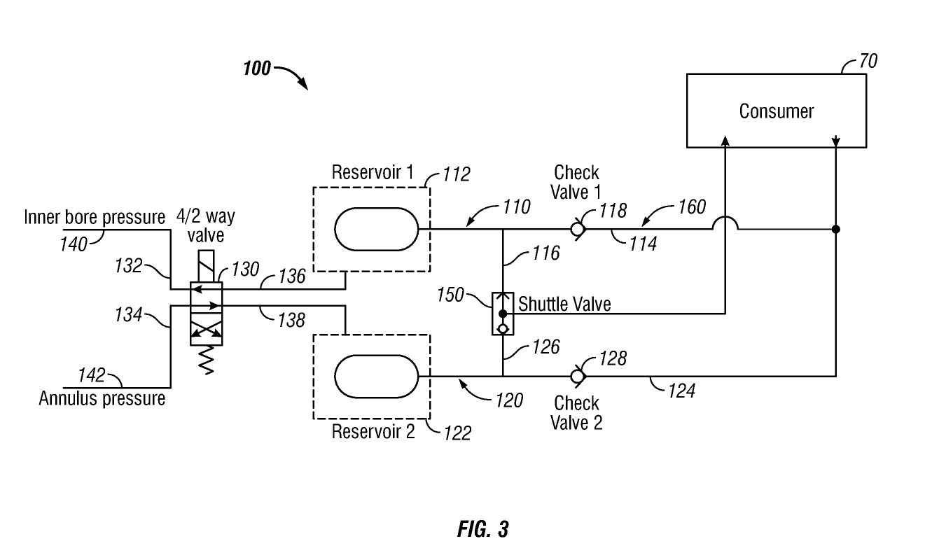

Referring now to FIG. 3, there is shown one system 100 for transforming an available pressure drop into a continuous hydraulic oil flow for a fluid circuit 160. The system 100 is a closed hydraulic system 100 that provides continuous pressurized fluid flow to a consumer 70 using a constant pressure differential as a power source. The pressure differential may be between a high pressure fluid in a tubular bore 60 (FIG. 2) and a lower pressure fluid in a bore annulus 42 (FIG. 2). The system 100 may include a first fluid branch 110, a second fluid branch 120, a first flow control device 130 that selectively connects the first and second fluid branches 110, 120, to the high and low pressure sources 140, 142, respectively, and a second flow control device 150 that selectively connects the first and second branches 110,120 to the consumer 70. As used throughout, connect means to establish a path or conduit through which pressure can be communicated.

In one embodiment, two different liquids are used by the system 100. The pressure differential for energizing the system 100 is provided by drilling “mud” circulating in the wellbore 12 (FIG. 1). A hydraulic fluid, such as “clean” oil, circulates through the fluid circuit 160 formed by the first branch 110, the second branch 120, and the consumer 70. Thus, the first control device 130 directs this pressure differential to the circuit 160 to establish fluid circulation in the circuit 160. Generally, the liquids may be considered different in that the fluids do not mix (e.g., they are isolated or separated from one another).

In one configuration, the first flow control device 130 may include flow lines 132, 134 that establish pressure communication with the high and low pressure sources 140, 142, respectively and flow lines 136, 138 that establish pressure communication with the first and second branches 110, 120, respectively. As used in, a flow control device generally refers to a device that can control the direction, velocity, or other flow parameter of a flowing fluid. The first flow control device 130 may be a valve configured to switch the source of the applied pressure to the branches 110, 120. As used throughout, switch denotes the physical action of changing the pressure source in a path or conduit. Thus, in one arrangement, the pressure control device 130 may apply bore pressure to the first branch 110 while applying annulus pressure to the second branch 120, and then switch the fluid paths to apply bore pressure to the second branch 120 while applying annulus pressure to the first branch 110. This switch may be performed according to a preset criteria (e.g., time duration), upon receiving a sensor signal, through a mechanical linkage, or any other suitable arrangement. In one non-limiting embodiment, the first flow control device 130 may be a four-port/two fluid path valve. That is, the valve may be configured to dynamically form two hydraulically isolated fluid paths using four fluid ports, and to selectively direct fluid through two outlet ports. A four-port/two fluid path valve is illustrative of suitable multi-port valves that can dynamically control multiple fluid paths. By, dynamic, it is mean that the fluid paths can be rearranged and reconfigured during operation in the wellbore.

This selective application of high pressure and low pressure to the two branches 110, 120 of the fluid circuit 160 causes the hydraulic fluid to flow in the fluid circuit 160. FIG. 3 shows one non-limiting configuration for the two branches 110, 120. The first branch 110 includes a first reservoir 112, a first inlet line 114, and a first outlet line 116. Likewise, the second branch 120 includes a second reservoir 122, a second inlet line 124, and a second outlet line 126. Merely for convenience, the first branch 110 will be discussed in greater detail with the understanding that the second branch 120 is formed in a substantially similar manner.

In one embodiment, the first reservoir 112 is configured to be responsive to an applied pressure. For example, the first reservoir 112 may be a bladder, a piston assembly, a variable-volume chamber, or any other structure that can transmit an applied pressure to a hydraulic fluid in the first branch 110. The first reservoir 112 may be formed of an impermeable material or use fluid isolation elements such as seals to prevent the bore fluid from leaking into the hydraulic fluid, or vice versa. The first outlet line 116 may be a conduit or channel through which fluid may flow between the first reservoir 112 and the second flow control device 150. The first inlet line 114 may be a channel through which fluid flows from the consumer 70 to the first reservoir 112. The first inlet line 114 may include a flow control device 118 such as a one-way or uni-directional valve to only permit flow from the consumer 70.

The second flow control device 150 establishes fluid communication between the reservoir in pressure communication with the high pressure source 140 and the consumer 70. Because the reservoirs alternately are subjected to high pressure, the second flow control device 150 is configured to alternately connect the reservoirs 112, 122 to the consumer 70. In one embodiment, the second flow control device 150 may be a shuttle valve, but may be any control valve that regulates the supply of fluid from more than one source into a single area of the circuit 160. The second flow control device 150 may be configured to periodically switch according to a preset criteria (e.g., time duration), upon receiving a command signal or a sensor signal, through a mechanical linkage, or any other suitable arrangement. As used herein, the resulting pressure change caused by the periodic switch performed by either the first or second flow control device 130, 150 will be called a cycle.

In one mode of operation, the first flow control device 130 places the first reservoir 112 in pressure communication with the high pressure source 140 and the second reservoir 122 in pressure communication with the low pressure source 142. The second flow control device 150 establishes fluid communication between the first reservoir 112 and the consumer 70 and blocks fluid communication between the second reservoir 122 and the consumer 70. Thus, hydraulic fluid, which has been pressurized by the high pressure source 140, flows from the first reservoir 112 through the first outlet line 116 to the second flow control device 150. The second flow control device 150 directs this hydraulic fluid to the consumer 70. Also, hydraulic fluid from the consumer 70 flows through the second inlet line 124 into the second reservoir 122. The second inlet line 124 may include a flow control device 128 such as a one-way or uni-directional valve to only permit flow from the consumer 70.

In response to a signal or based on some other condition, the first flow control device 130 re-aligns the fluid flow such that the first reservoir 112 is in pressure communication with the low pressure source 142 and the second reservoir 122 is in pressure communication with the high pressure source 140. Also, the second flow control device 150 now blocks fluid communication between the first reservoir 112 and the consumer 70 and establishes fluid communication between the second reservoir 122 and the consumer 70. Thus, hydraulic fluid, which has been pressurized by the high pressure source 140, flows from the second reservoir 122 through the second outlet line 126 to the second flow control device 150. The second flow control device 150 directs this hydraulic fluid to the consumer 70. Also, hydraulic fluid from the consumer 70 flows through the second inlet line 114 into the first reservoir 112. This operation may be repeated as needed.

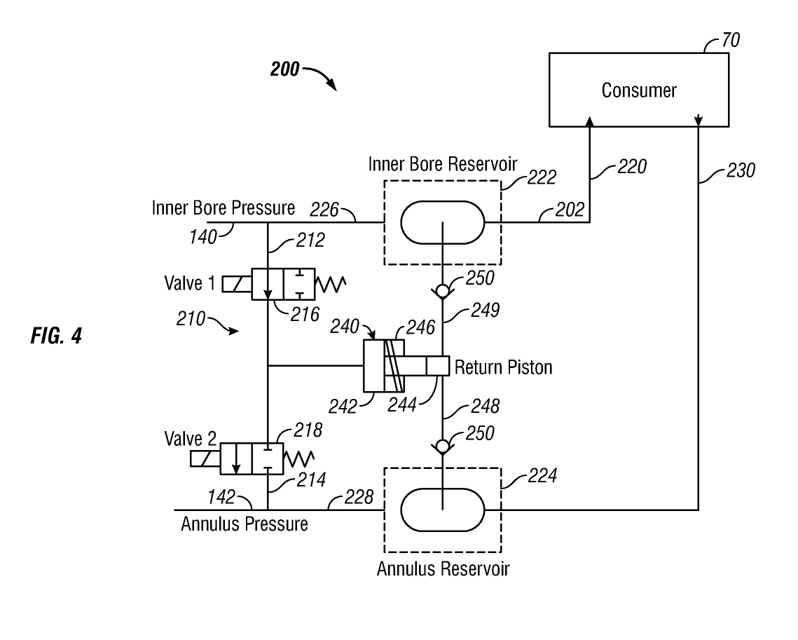

Referring now to FIG. 4, there is shown another system 200 for transforming an available pressure drop into a continuous hydraulic oil flow for a fluid circuit 202. The system 200 is also a closed fluid circuit that provides a continuous pressurized flow to a consumer 70 using a constant pressure differential as a power source. The pressure differential may be between a high pressure fluid in a tubular bore 60 (FIG. 2) and a lower pressure fluid in a wellbore annulus 42 (FIG. 2). The system 200 may include a flow control device 210 that uses the pressure differential to cause fluid circulation in a closed fluid circuit 202. The closed fluid circuit 202 may have a supply branch 220 that supplies fluid to the consumer 70 and a return branch 230 that receives fluid from the consumer 70. The supply branch 220 and return branch 230 may have reservoirs, 222, 224, respectively.

As before, two different fluids are used by the system 200. The pressure differential for energizing the system 200 is provided by a wellbore fluid, such as a drilling fluid circulating in the wellbore. A hydraulic fluid, such as oil, circulates through the fluid circuit 202.

In one configuration, the flow control device 210 may include flow lines 212, 214 that establish pressure communication with the high and low pressure sources, respectively and a flow device 240. As used herein, a flow device is a device for raising, compressing, or transferring fluids. In one embodiment, the flow device 240 may be a pump that includes a piston 242 that reciprocates in a chamber 244 that receives hydraulic fluid from the return branch 230 and supplies hydraulic fluid to the supply branch 220. The flow control device 210 may include valve members 216, 218 that selectively connect the high pressure and low pressure sources 140, 142 to the piston 242. For example, the valve members 216, 218 may be sequentially actuated to periodically switch the source of the applied pressure to the piston 242. In one arrangement, coupling the high pressure source to the piston 242 causes the piston 242 to displace hydraulic fluid out of the chamber 244 and coupling the low pressure source to the piston 242 causes the piston 242 to draw hydraulic fluid into the chamber 244. A biasing member, such as a spring 246, may be used to assist the piston 242 in overcoming the applied pressure to draw hydraulic fluid into the chamber 244. The piston 242 may be configured such that the surface in contact with the wellbore fluid has less surface area than the surface in contact with the hydraulic fluid. The difference in surface areas multiplies the force generated by the wellbore fluid. Operation of the valve members may be controlled by a processor programmed with a preset criteria (e.g., time duration), by an actuator receiving a sensor signal, through a mechanical linkage, or any other suitable arrangement.

The reciprocation of the piston 242 pumps fluid from the return branch 230 to the supply branch 220. For example, the piston 242 may draw fluid through a line 248 coupled to the return reservoir 224 and eject fluid through a line 249 coupled to the supply reservoir 222. Uni-directional valves 250 may be positioned on the lines 248, 249 to cause fluid to flow in the desired direction. It should be understood that a reciprocating piston 242 or pump is only one non-limiting pump device that may be energized using the pressure differential.

In one embodiment, the supply and return reservoirs 222, 224 are configured to be responsive to an applied pressure. As noted previously, the reservoirs may be a bladder, a piston assembly, a variable-volume chamber, or any other structure that can transmit an applied pressure to a hydraulic fluid in the circuit 202. The reservoirs 222, 224 may be formed of an impermeable material or use fluid isolation elements such as seals to prevent the wellbore fluid from leaking into the hydraulic fluid, or vice versa. Pressure communication between the supply reservoir 222 and the high pressure source 140 may be provided by a line 226 and pressure communication between the return reservoir 224 and the low pressure source 142 may be provided by a line 228. The lines 226, 228 have fluid communication with their respective pressure sources 140, 142.

In one mode of operation, the line 226 pressurizes the supply reservoir 222 using the high pressure source 140 and the line 228 pressurizes the return reservoir 224 using the low pressure source 142. The flow control device 210 applies high pressure to the piston 242 by opening the valve 216. In response, the piston 242 translates and ejects fluid out of the line 249. The ejected fluid flows into the supply reservoir 222, which then circulates fluid to the consumer 70. Next, the flow control device 210 closes the valve 216 and opens the valve 218, which then allows the biasing member 246 to displace the piston 242. The piston 242 forces the wellbore fluid out to the low pressure source 142 via the open valve 218. As the piston 242 moves, the chamber 244, which is increasing in volume, draws in fluid from the return reservoir 224 via the line 248. The opening and closing of the valves 216, 218, therefore, cause the piston 242 to reciprocate and pump hydraulic fluid from the return reservoir 224 to the supply reservoir 222.

From the above, it should be appreciated that what has been described includes, in part, devices for energizing a consumer of a pressurized fluid. One illustrative device may include a fluid circuit in fluid communication with the consumer, the fluid circuit having a first and a second reservoir; and a flow control device in pressure communication with a high pressure source and a low pressure source, the flow control device being configured to cycle a pressure applied to the first and the second reservoirs using the high pressure source and the low pressure source. Another illustrative device may include a fluid circuit in fluid communication with the consumer, the fluid circuit including a first branch supplying pressurized fluid to the reservoir, a second branch receiving fluid from the reservoir, a flow device configured to flow fluid from the second branch to the first branch, and a flow control device in fluid communication with the flow device, the flow control device being configured to cycle a pressure applied to the flow device using the high and the low pressure source.

From the above, it should be appreciated that what has been described includes, in part, methods for energizing a consumer of a pressurized fluid. The methods may use a first pressure source and a second pressure source having a pressure lower than the first pressure source. One illustrative method may include circulating fluid using a first and a second reservoir in fluid communication with the consumer; and cycling a pressure applied to the first and the second reservoirs using a flow control device in pressure communication with the first pressure source and the second pressure source. Another illustrative method may include providing fluid communication with the consumer using a fluid circuit having a first and a second branch, flowing a fluid from the second branch to the first branch using a flow device, and cycling a pressure applied to the flow device using the first and the second pressure source.

It should be understood that the teachings of the present disclosure may be useful in energizing fluid circuits that may be utilized outside of the drilling context. For example, intelligent well completions, work-overs, re-completions, logging, and other post-drilling activities may use hydraulic systems that could be energized using embodiments of the present disclosure. Moreover, the teachings of the present disclosure are not limited to hydrocarbon producing wells. For instances, wells used for geothermal applications or water wells. Still further, the teachings of the present disclosure may be used in surface applications such as pipelines.

While the foregoing disclosure is directed to the one mode embodiments of the disclosure, various modifications will be apparent to those skilled in the art. It is intended that all variations within the scope of the appended claims be embraced by the foregoing disclosure.

What is claimed is:

1. An apparatus for energizing a consumer of a pressurized fluid using a first pressure source and a second pressure source having a pressure lower than the first pressure source, comprising:
a fluid circuit in fluid communication with the consumer, the fluid circuit having a first and a second reservoir; and
a flow control device in pressure communication with the first pressure source and the second pressure source, the flow control device being configured to cycle a pressure applied to the first and the second reservoirs using the first pressure source and the second pressure source.

2. The apparatus of claim 1, wherein the fluid circuit includes a first branch providing fluid communication between the first reservoir and the consumer, a second branch providing fluid communication between the second reservoir and the consumer, and a second flow control device configured to alternately connect the first branch and the second branch to the consumer.

3. The apparatus of claim 2, wherein the second flow control device is a valve.

4. The apparatus of claim 1, further comprising a fluid isolation barrier associated with each of the first and the second reservoirs, the fluid isolation barrier separating a first fluid associated with the flow control device from a second fluid associated with the fluid circuit.

5. The apparatus of claim 1, wherein the flow control device is a multi-port valve having a plurality of dynamic flow paths, the dynamic flow paths being configured to:
switch pressure communication between the first pressure source and the first reservoir to pressure communication between the first pressure source and the second reservoir; and
switch pressure communication between the second pressure source and the second reservoir to pressure communication between the second pressure source and the first reservoir.

6. The apparatus of claim 1, wherein the flow control device includes a first line configured to receive fluid from a bore of a wellbore tubular and a second line configured to receive fluid from a wellbore annulus.

7. The apparatus of claim 6, further comprising a bottomhole assembly configured to be conveyed along a wellbore in a formation with the wellbore tubular, the consumer being associated with the bottomhole assembly.

8. The apparatus of claim 1, wherein the flow device is a pump that includes a reciprocating piston.

9. A method for energizing a consumer of a pressurized fluid using a first pressure source and a second pressure source having a pressure lower than the first pressure source, comprising:
providing fluid communication with the consumer using a fluid circuit having a first and a second branch;
flowing a fluid from the second branch to the first branch using a flow device; and
cycling a pressure applied to the flow device using the first and the second pressure source.

10. The method of claim 9, wherein the flow device is a pump that includes a reciprocating piston.

11. The method of claim 9, wherein the pressure is cycled by a flow control device that includes a first valve member and a second valve member, the first and the second valve member being configured to selectively connect the high pressure and low pressure sources to the flow device, respectively.

12. The method of claim 9, wherein the high pressure source is a fluid flowing through a bore of a wellbore tubular, and the low pressure source is a fluid flowing in a wellbore annulus.

13. The method of claim 12, further comprising circulating the fluid into a wellbore via the bore of the wellbore tubular and out of the wellbore via the wellbore annulus.

14. The method of claim 9, further comprising disposing a bottomhole assembly in a wellbore, wherein the consumer is associated with the bottomhole assembly.

15. The method of claim 9, further comprising substantially isolating a fluid associated with the high pressure source and the low pressure source from the pressurized fluid.

16. A method for energizing a consumer of a pressurized fluid using a first pressure source and a second pressure source having a pressure lower than the first pressure source, comprising:
circulating fluid using a first and a second reservoir in fluid communication with the consumer; and
cycling a pressure applied to the first and the second reservoirs using a flow control device in pressure communication with the first pressure source and the second pressure source.

17. The method of claim 16, wherein the first reservoir is in fluid communication with the consumer via a first branch and the second reservoir is in fluid communication with the consumer via a second branch, and further comprising alternately connecting the first branch and the second branch to the consumer.

18. The method of claim 16, wherein a valve is configured to alternately connect the first branch and the second branch to the consumer.

19. The method of claim 16, wherein the high pressure source is a fluid flowing through a bore of a wellbore tubular, and the low pressure source is a fluid flowing in a wellbore annulus.

20. The method of claim 16, further comprising substantially isolating a fluid associated with the high pressure source and the low pressure source from the pressurized fluid.
